(19) United States
(12) Patent Application Publication
(10) Pub. No.: US 2007/0211063 A1
(43) Pub. Date: Sep. 13, 2007

(54) Display program, data structure and display device

(75) Inventor: Takashi Sawazaki, Chofu (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/706,050

(22) Filed: Feb. 13, 2007

(30) Foreign Application Priority Data
Mar. 8, 2006 (JP) 2006-062747

(51) Int. Cl. G06T 11/00

(52) U.S. Cl. 345/467

(57) ABSTRACT

A display program for displaying a character by acquiring an instruction for rendering each element composing the character and rendering the each element based on the instruction, the program being executed on a computer, includes a determination function of determining whether the acquired instruction is a complex glyph instruction indicating the use of a complex glyph consisting of a combination of plural parts glyphs as a glyph of the character or other instruction and a rendering function of rendering each of the parts glyphs based on the information concerning the parts glyph acquired following the complex glyph instruction if the acquired instruction is determined as the complex glyph instruction.

The entire disclosure of Japanese Patent Application No. 2006-062747, filed Mar. 8, 2006 is expressly incorporated by reference herein.

### BACKGROUND

1. Technical Field

The present invention relates to a display program, a data structure and a display device for displaying a character by acquiring two or more information for rendering elements composing the character and rendering the elements based the information.

2. Related Art

Conventionally, a display device of this kind is provided, for example, which displays a character by acquiring various kinds of information such as two or more instructions or the information concerning the glyph for rendering each element composing the character and rendering each element based on the information (e.g., refer to JP-A-7-325562).

In such display device, it is common that a flag indicating whether or not the information concerns the parts glyph (glyph making up the complex glyph) is appended to all the acquired information, and every time the information is acquired, it is determined whether or not the information is the information concerning the parts glyph by reading the flag, in which if the information concerns the parts glyph, the complex glyph is rendered by rendering each parts glyph based on the information.

### SUMMARY

However, with the prior art, since the reading of the flag and the determination are performed for all the information, the processing amount is increased, and the processing speed is decreased.

The invention has been achieved to solve the unsolved problems with the prior art, and it is an object of the invention to provide a display program, a data structure and a display device in which the processing speed for the rendering process can be increased.

To accomplish the above object, the display device of the invention provides a display program for displaying a character by acquiring an instruction for rendering the each element composing the character and rendering each element based on the instruction, the program being executed on a computer, comprising a determination function of determining whether the acquired instruction is a complex glyph instruction indicating the use of a complex glyph consisting of a combination of plural parts glyphs as a glyph of the character or other instruction and a rendering function of rendering each of the parts glyphs based on the information concerning the parts glyph acquired following the complex glyph instruction if the acquired instruction is determined as the complex glyph instruction.

Also, the information concerning the parts glyph may contain a glyph index of the parts glyph, and the rendering function comprises a parts glyph acquisition function of acquiring the instruction indicated by the glyph index of the parts glyph and a first parts glyph rendering function of rendering the parts glyph based on the acquired instruction.

Further, the invention provides a data structure for use in a display program for displaying a character by acquiring an instruction for rendering each element composing the character and rendering the each element based on the instruction, wherein a complex glyph instruction indicating the use of a complex glyph consisting of a combination of plural parts glyphs as a glyph of the character is arranged before the information concerning the parts glyph.

Also, the invention provides a display device for displaying a character by acquiring an instruction for rendering each element composing the character and rendering the each element based on the instruction, comprising a determination section of determining whether the acquired instruction is a complex glyph instruction indicating the use of a complex glyph consisting of a combination of plural parts glyphs as a glyph of the character or other instruction and a rendering section of rendering each of the parts glyphs based on the information concerning the parts glyph acquired following the complex glyph instruction if the acquired instruction is determined as the complex glyph instruction.

With the above constitution, unlike a method in which a flag indicating whether or not the information concerns the parts glyph is appended to all the acquired information, and every time the information is acquired, it is determined whether or not the information is the information concerning the parts glyph by reading the flag, for example, it is unnecessary that the reading of the flag and the determination are performed for all the information, whereby the constitution is simplified, so that the processing speed can be increased.

### BRIEF DESCRIPTION OF THE DRAWINGS

FIG. 1 is a block diagram showing the internal configuration of a display device according to one embodiment of the invention;

FIG. 2 is an explanatory view for explaining the mnemonics;

FIG. 3 is an explanatory view for explaining the functional configuration of the CPU;

FIG. 4 is a flowchart showing the flow of a bit map generation process;

FIG. 5 is a flowchart showing the flow of the first rendering process;

FIG. 6 is a flowchart showing the flow of the second rendering process;

FIGS. 7A and 7B are explanatory views for explaining the operation of the display device;

FIGS. 8A and 8B are explanatory views for explaining the operation of the display device;

FIGS. 9A and 9B are explanatory views for explaining the operation of the display device;

FIGS. 10A and 10B are explanatory views for explaining a modified embodiment of the invention;

FIG. 11 is an explanatory view for explaining the operation of the conventional display device; and

FIG. 12 is an explanatory view for explaining the operation of the conventional display device.

### DETAILED DESCRIPTION OF THE PREFERRED EMBODIMENTS

A display device according to one embodiment of the invention will be described below with reference to the drawings.

Configuration of Display Device

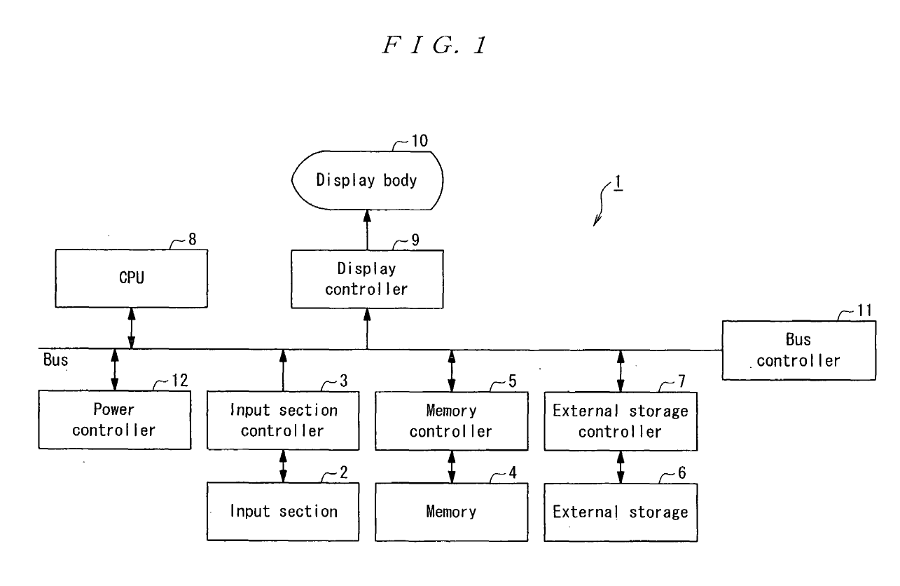

FIG. 1 is a block diagram showing the internal configuration of the display device according to one embodiment of the invention. The display device 1 comprises an input section 2, an input section controller 3, a memory 4, a memory controller 5, an external storage 6, an external storage controller 7, a CPU 8, a display controller 9, a display body 10, a bus controller 11 and a power source controller 12, as shown in FIG. 1.

The input section 2 is a device such as a mouse or a keyboard that is manipulated to instruct the rendering of character. And the input section 2 outputs a character rendering instruction via the input section controller 3 to the CPU 8, if an operation for instructing the rendering of character is made.

The input section controller 3 controls the data transfer between the input section 2 and the CPU 8.

The memory 4 is formed with a work area for expanding various kinds of program when the CPU 8 executes the program, and a storage area for storing the data related with various kinds of program executed by the CPU 8 and the data of information to be displayed.

The memory controller 5 controls the data transfer between the memory 4 and the CPU 8.

The external storage 6 stores various kinds of program such as a basic control program or an application program executed by the CPU 8 and the data related with various kinds of program.

The external storage controller 7 controls the data transfer between the external storage 6 and the CPU 8.

The CPU 8 controls each of the sections 2 to 12 by reading various kinds of program stored in the external storage 6, and expanding it over the work area formed in the memory 4.

Specifically, the CPU 8 performs a bit map generation process, if a character rendering instruction is outputted from the input section 2. And in the bit map generation process, the rendering instruction data (data composed of a plurality of mnemonics for rendering each element composing the character, or the data in which the mnemonics are arranged in a prescribed order) is acquired based on the character code of the character, the mnemonics are acquired one by one in the prescribed order from the rendering instruction data, and a bit map of the rendering instructed character is generated based on the mnemonics.

If the mnemonic (ComplexGlyph) indicating a complex glyph (glyph consisting of a combination of plural glyphs (parts glyphs)) is acquired, the CPU 8 generates the contour data of each parts glyph based on the glyph index, affine parameter and offset of the parts glyph arranged next to the ComplexGlyph, and generates the bit map of the character represented by the complex glyph based on the contour data.

That is, the mnemonics making up the rendering instruction data have the information concerning the parts glyph of the complex glyph indicated by the ComplexGlyph after the ComplexGlyph.

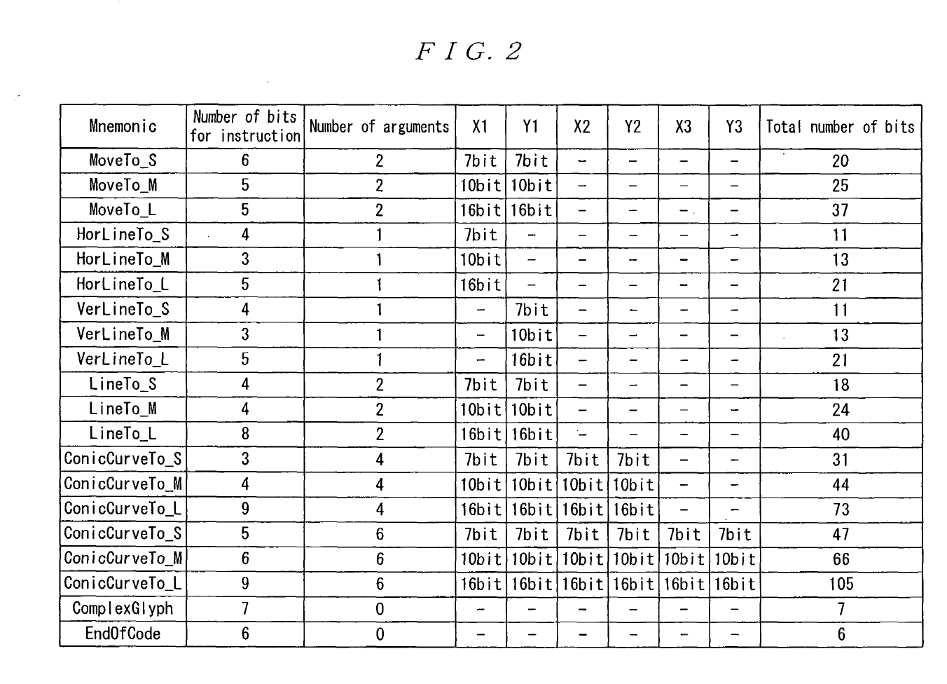

Herein, the mnemonics other than the ComplexGlyph include MoveTo_S, MoveTo_M, MoveTo_L (coordinate shift code of processing object), HorLineTo_S, HorLineTo_M, HorLineTo_L (horizontal line rendering code), VerLineTo_S, VerLineTo_M, VerLineTo_L (vertical line rendering code), LineTo_S, LineTo_M, LineTo_L (arbitrary line rendering), ConicCuraveTo_S, ConicCuraveTo_M, ConicCuraveTo_L (secondary Bezier curve rendering code), CubicCuraveTo_S, CubicCuraveTo_M and CubicCuraveTo_L (tertiary Bezier curve rendering code), as shown in FIG. 2.

ComplexGlyph is a code indicating that a certain number of parts glyphs with the glyph index, affine parameter and offset continue to compose the complex glyph.

Further, EndOfCode is a code indicating the last mnemonic making up the rendering instruction data.

The display controller 9 renders the bit map on the display body 10, if the bit map is generated by the CPU 8.

The display body 10 comprises a memorable display body (cholesteric liquid crystal) capable of holding the display contents even if power supply is stopped. And the display body 10 has the display contents rewritten by the rendering operation of the display controller 9.

The bus controller 11 controls the data transfer between the CPU 8 and each of the sections 2 to 12.

The power controller 12 controls the power supply to each of the sections 2 to 12 in the display device 1 in accordance with a command from the CPU 8.

Functional Configuration of CPU

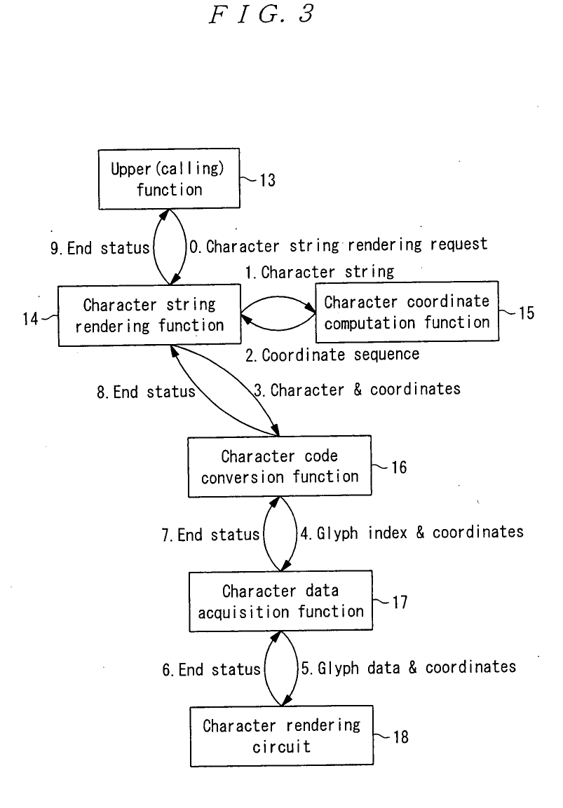

FIG. 3 is a block diagram showing the functional configuration of the CPU 8. As shown in FIG. 3, the CPU 8 comprises an upper function 13, a character string rendering function 14, a character coordinate computation function 15, a character code conversion function 16, a character data acquisition function 17 and a character rendering circuit 18.

The upper function 13 outputs a character string rendering request for rendering the character string to the character string rendering function 14, if a character string rendering instruction is outputted from the input section 2.

The character string rendering function 14 outputs a character code group of the character string corresponding to a character string rendering request to the character coordinate computation function 15, if the character string rendering request is outputted from the upper function 13.

Also, the character string rendering function 14 outputs the combinations of the coordinates constituting a coordinate sequence and the character code corresponding to the coordinates one by one to the character code conversion function 16, if the coordinate sequence is outputted corresponding to the output of the character string group from the character coordinate computation function 15.

Moreover, the character string rendering function 14 outputs an end status to the upper function 13, if the end status is outputted from the character code conversion function 16.

The character coordinate computation function 15 computes the coordinates of the rendering position for each character code included in the character code group outputted from the character string rendering function 14 and outputs a coordinate sequence made up of the computation results to the character string rendering function 14.

The character code conversion function 16 converts the character code into glyph index, and outputs a combination of the conversion result and the coordinates to the character data acquisition function 17, if a set of character code and coordinates is outputted from the character string rendering function 14.

Also, the character code conversion function 16 outputs an end status to the character string rendering function 14, if the end status is outputted from the character data acquisition function 17.

The character data acquisition function 17 acquires the rendering instruction data based on the glyph index, and outputs a combination of the acquisition result (glyph data) and the coordinates to the character rendering circuit 18, if a set of glyph index and coordinates is outputted from the character code conversion function 16.

Also, the character data acquisition function 17 outputs an end status to the character code conversion function 16, if the end status is outputted from the character rendering circuit 18.

Moreover, the character data acquisition function 17 acquires the glyph data of the parts glyphs one by one in a prescribed order, based on the glyph index, affine parameter and offset of the parts glyph arranged next to the ComplexGlyph, and outputs the glyph data and the coordinates corresponding to the glyph data to the character rendering circuit 18, if the end status outputted from the character rendering circuit 18 is an abnormal end status for complex glyph (end status indicating the abnormal end of acquiring the ComplexGlyph).

The character rendering circuit 18 acquires the mnemonics one by one in a prescribed order from the glyph data and generates the bit map of the character corresponding to the glyph data, based on the mnemonics, if a set of glyph data and coordinate is outputted from the character data acquisition function 17.

Also, the character rendering circuit 18 outputs the end status to the character data acquisition function 17, after generating the bit map. If ComplexGlyph is acquired, an abnormal end status for complex glyph is outputted to the character data acquisition function 17 without generating the bit map.

Operation of CPU

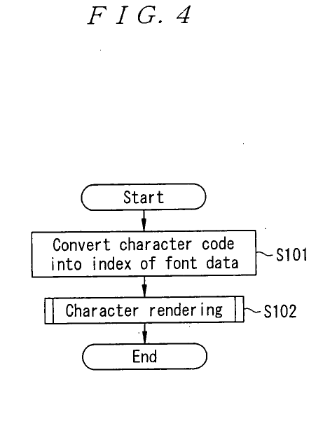

Referring to a flowchart of FIG. 4, a bit map generation process performed by the CPU 8 will be described below.

This bit map generation process is performed if a character rendering instruction is made. First of all, at step S101, the character code of the rendering instructed character is acquired and converted into the glyph index of font data.

At the next step S102, a first character rendering process (hereinafter described) for rendering the rendering instructed character on the display body is performed, based on the glyph index converted at step S101, and this operation process is ended.

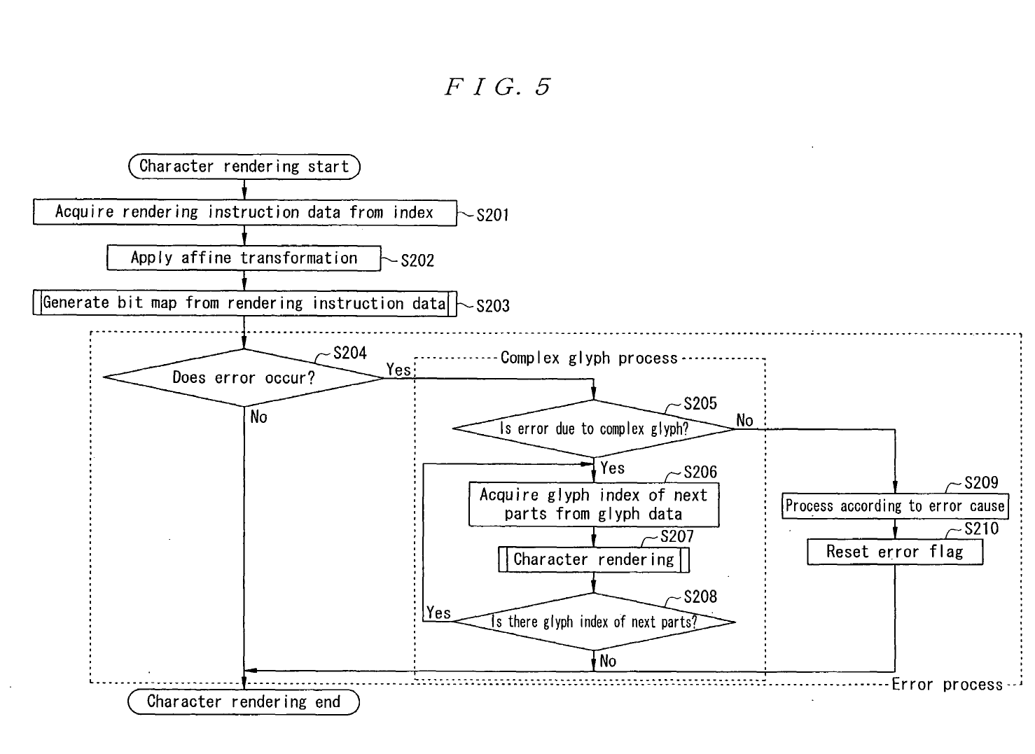

Referring to a flowchart of FIG. 5, the character rendering process performed at step S102 will be described below.

At step S201, this bit map generation process firstly acquires the rendering instruction data based on the glyph index converted at step S101.

At the next step S202, the rendering instruction data acquired at step S201 is subjected to affine transformation.

At the next step S203, a second character rendering process (hereinafter described) for generating the bit map based on the rendering instruction data subjected to affine transformation at step S202 is performed.

At the next step S204, it is determined whether or not an error occurs at step S203 or the parts glyph is processed at step S203. And if the error occurs or the parts glyph is processed (Yes), the procedure goes to the step S205, or if the error does not occur or the parts glyph is not processed (No), this operation process is ended.

At step S205, it is determined whether or not the error determined at step S204 is due to ComplexGlyph. And if the error is due to Complexglyph (Yes), the procedure goes to step S206, or if the error is not due to Complexglyph (No), the procedure goes to step S209.

At step S206, the glyph index, affine parameter and offset of the parts glyph arranged next to the ComplexGlyph acquired at step S302 described later are acquired.

At step S207, the first character rendering process is recursively performed.

At the next step S208, it is determined whether or not there are the glyph index, affine parameter and offset of the parts glyph arranged next to the glyph index acquired at step S206. And if there are the glyph index and so on of the next parts glyph (Yes), the procedure goes to step S206, or if there are not the glyph index and so on of the next parts glyph (No), this operation process is ended.

On the other hand, at step S209, a process corresponding to an error cause of the error determined at step S204 is performed.

At the next step S210, an error flag indicating that the error occurs is reset, and this operation process is ended.

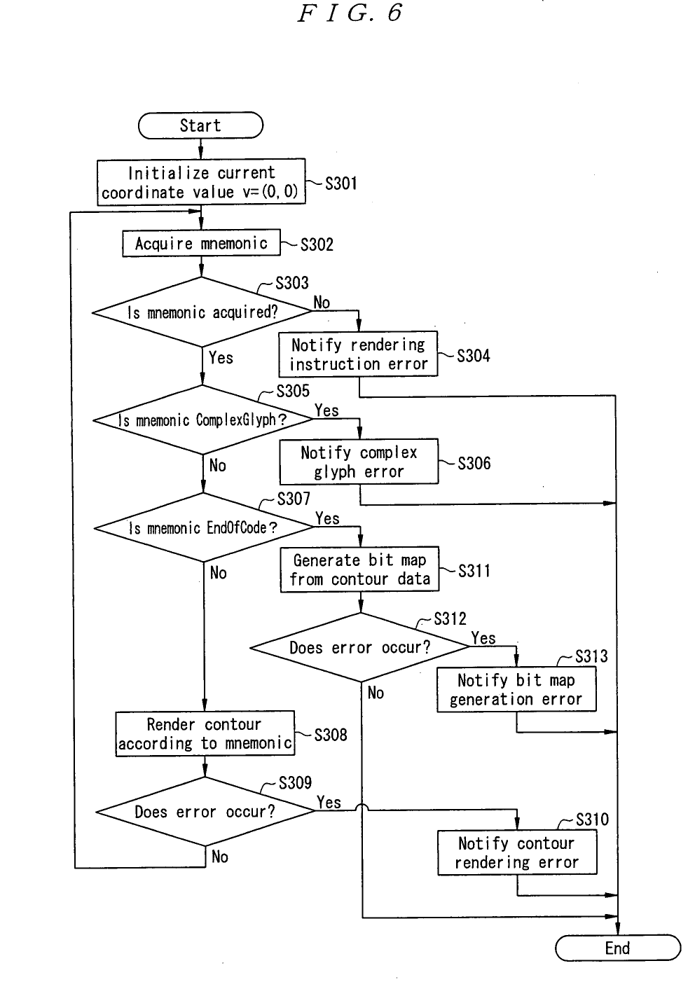

Referring to a flowchart of FIG. 6 a second rendering process performed at step S203 will be described below.

In this second rendering process, first of all, the coordinate value (current coordinate value) v indicating the pixel to be processed is set to (0,0) at step S301.

At the next step S302, one mnemonic is acquired in a prescribed order from the rendering instruction data subjected to affine transformation at step S202.

At the next step S303, it is determined whether or not the mnemonic is acquired at step S302. And if the mnemonic is acquired (Yes), the procedure goes to step S305, or if the mnemonic is not acquired (No), the procedure goes to step S304.

At step S304, a rendering instruction error notification is made to notify that the mnemonic is not acquired, and this operation process is ended.

On the other hand, at step S305, it is determined whether or not the mnemonic acquired at step S302 is ComplexGlyph. And if the mnemonic is ComplexGlyph (Yes), the procedure goes to step S306, or if the mnemonic is not ComplexGlyph (No), the procedure goes to step S307.

At step S306, a complex glyph error notification is made to report that the ComplexGlyph is acquired, and this operation process is ended.

On the other hand, at step S307, it is determined whether or not the mnemonic acquired at step S302 is EndOfCode. And if the mnemonic is EndOfCode (Yes), the procedure goes to step S311, or if the mnemonic is not EndOfCode (No), the procedure goes to step S308.

At step S308, the contour data of the rendering instructed character is generated based on the mnemonic acquired at step S302.

At the next step S309, it is determined whether or not an error occurs at step S308. And if the error occurs (Yes), the procedure goes to step S310, or if the error does not occur (No), the procedure returns to step S302.

At step S310, a contour rendering error notification is made to report that the contour data is not generated, and this operation process is ended.

On the other hand, at step S311, a bit map of the rendering instructed character is generated based on the contour data generated at step S308.

At the next step S312, it is determined whether or not an error occurs at step S311. And if the error occurs (Yes), the procedure goes to step S313, or if the error does not occur (No), this operation process is ended.

At step S313, a bit map generation error notification is made to report that the bit map is not generated, and this operation process is ended.

Operation of Display Device

The operation of the display device 1 according to this embodiment will be described below based on a specific situation.

First of all, suppose that the user performs an operation of instructing the rendering of character and the input section 2 outputs a character rendering instruction to the CPU 8. Then, the CPU 8 performs the bit map generation process. The character code of the rendering instructed character is firstly acquired and converted into the glyph index of font data at step S101, and the first character rendering process is performed based on the glyph index at step S102, as shown in FIG. 4.

If the first character rendering process is started, the rendering instruction data is firstly acquired based on the glyph index at step S201, and subjected to affine transformation at step S202, and the second rendering process is performed based on the rendering instruction data subjected to affine transformation at step S203, as shown in FIG. 5.

If the second rendering process is started, the coordinate value (current coordinate value) v indicating the pixel to be processed is firstly set to (0,0) at step S301, and one mnemonic is acquired in a prescribed order from the rendering instruction data subjected to affine transformation at step S302, and if the mnemonic is ComplexGlyph, the determinations at steps S303 and S304 are “Yes”, the complex glyph error notification is made at S306, and this operation process is ended, as shown in FIG. 6.

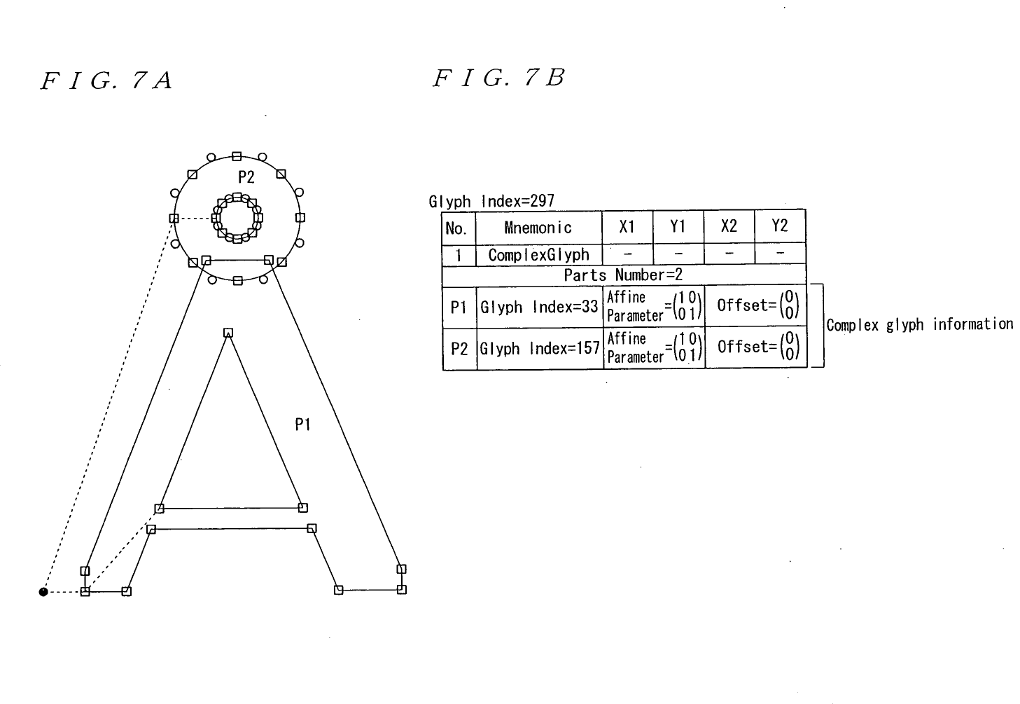

As shown in FIG. 5, the determinations at steps S204 and S205 are “Yes”, one set of glyph index (33), affine parameter and offset of the parts glyph making up the complex glyph as shown in FIGS. 7A and 7B is acquired at step S206, and the first character rendering process for generating the bit map of the parts glyph (A) based on the glyph index and so on is recursively performed at step S207.

If the first character rendering process is started, the rendering instruction data is acquired based on the glyph index and so on at step S201, the rendering instruction data is subjected to affine transformation at step S202, and the second rendering process is performed based on the rendering instruction data subjected to affine transformation at step S203, as shown in FIG. 5.

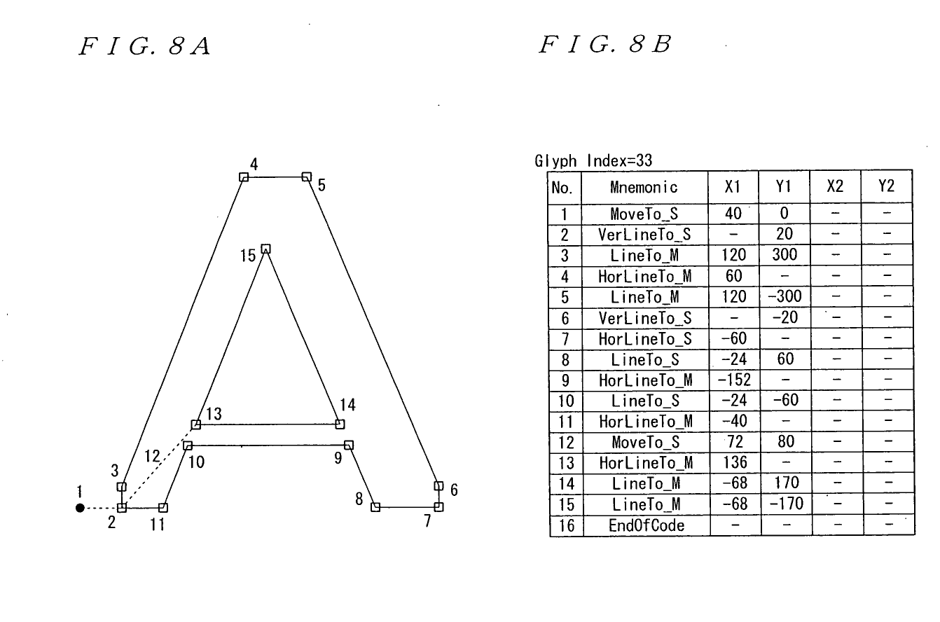

If the second rendering process is started, the steps S301 to S303 are performed, the mnemonic (MoveTo_M) of the parts glyph as shown in FIGS. 8A and 8B is acquired, the determinations at steps S305 and S307 are “No”, the current coordinate value v is updated according to the acquired mnemonic at step S308, and the determination at step S309 is “No”, whereby the above flow from step S302 is repeated until the contour data (A) of the parts glyph is generated, as shown in FIG. 6.

Suppose that EndOfCode is acquired while the flow is repeated. Then, the determination at step S307 is “Yes”, the bit map of the parts glyph (A) is generated based on the generated contour data at step S311, the determination at step S312 is “No”, and this operation process is ended.

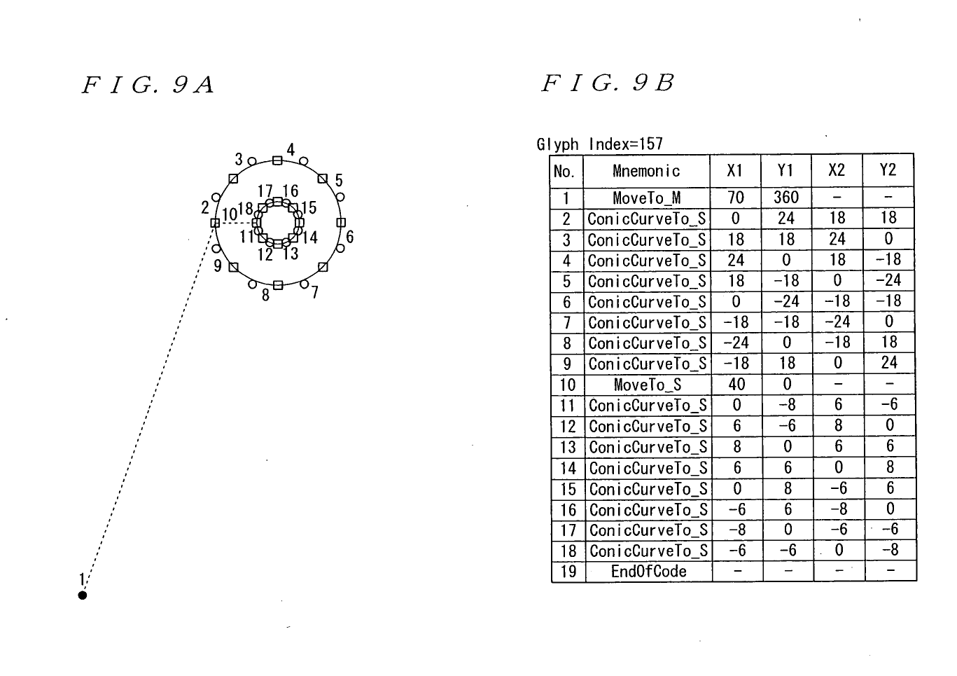

And the determination at step S208 is “Yes”, the glyph index (157), affine parameter and offset of the second parts glyph making up the complex glyph are acquired at step S206, the first character rendering process is recursively performed at step S207, whereby the bit map of the parts glyph (◯) as shown in FIGS. 9A and 9B is generated based on the glyph index and so on through the steps S201 to S207, the determination at step S208 is “No”, and this operation process is ended, shown in FIG. 5.

Also, the display controller 9 renders the generated bit map (A,◯) on the display body 10, and displays the rendering instructed character (A) on the display body 10.

In this manner, in the display device of this embodiment, if the ComplexGlyph is acquired, the parts glyph is rendered based on the glyph index, affine parameter and offset (information concerning the parts glyph) acquired following the ComplexGlyph. Therefore, unlike a method in which a flag indicating whether the information concerns the parts glyph or not is appended to all the acquired information, and every time the information is acquired, it is determined whether or not the information concerns the parts glyph by reading the flag, for example, it is unnecessary that the reading of the flag and the determination are made for all the information, whereby the constitution is simplified, so that the processing speed is increased.

In a case where the above function of rendering the character is implemented by hardware, for example, the hardware for the reading of the flag and the determination is unnecessary, unlike the above-mentioned method using the flag, so that the packaging area can be reduced.

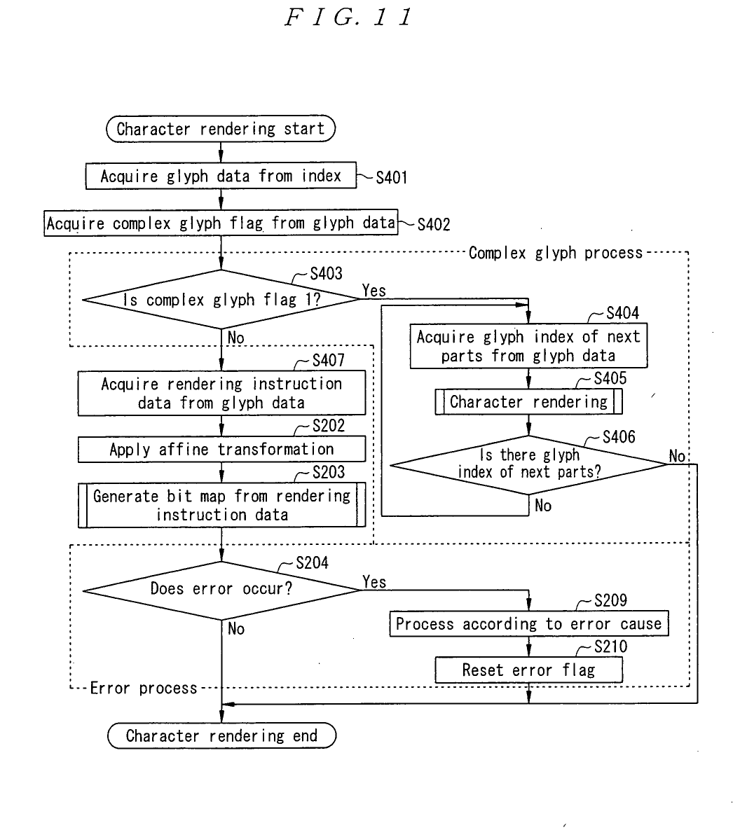

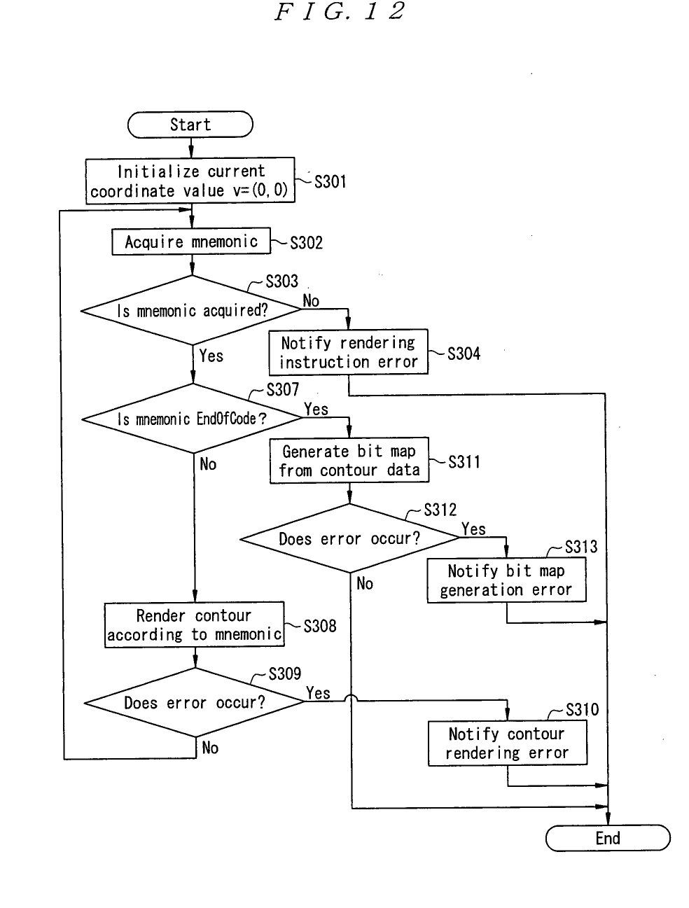

Incidentally, in the conventional display device, in the first rendering process, the glyph data is acquired from the glyph index (step S401), the complex glyph flag is acquired from the glyph data (step S402), if the complex glyph flag is “1” (“Yes” at step S403), the glyph index and so on of the parts arranged next are acquired, and the character rendering process is performed (steps S404 to S406), as shown in FIG. 11. In the second rendering process, there are no steps (steps S305, S306) of making the complex glyph error notification in the case of ComplexGlyph, as shown in FIG. 12.

In the above embodiment, the step S305 of FIG. 6 constitutes a determination function as defined in claims; the steps S204 to S208 of FIG. 5 constitutes a rendering function; the step S206 of FIG. 5 constitutes a parts glyph acquisition function; the step S207 of FIG. 5 constitutes a first parts glyph rendering function; the CPU 8 of FIG. 1 and the step S305 of FIG. 6 constitute a determination section; and the CPU 8 of FIG. 1 and the steps S204 to S208 of FIG. 5 constitute a rendering section.

Also, the display device of the invention is not limited to the contents of the above embodiment, but various variations may be made without departing from the scope or spirit of the invention.

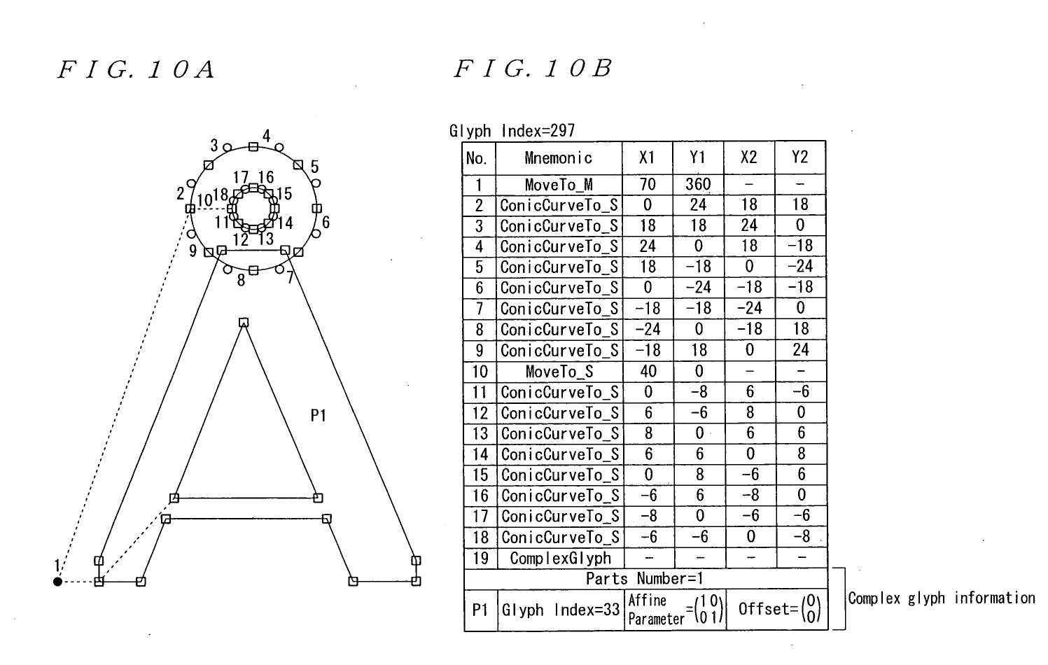

In the above embodiment, in rendering the character “Å”, the rendering instruction data is used in which the glyph index and so on defining the parts glyph “A” and the glyph index and so on defining “◯” are arranged after ComplexGlyph, but the invention is not limited thereto. For example, the rendering instruction data in which ComplexGlyph and the glyph index defining “◯” are arranged after the glyph index and so on defining the parts glyph “A” may be used, as shown in FIGS. 10A and 10B.

What is claimed is:

1. A display program for displaying a character by acquiring an instruction for rendering each element composing the character and rendering the each element based on the instruction, the program being executed on a computer, comprising a determination function of determining whether the acquired instruction is a complex glyph instruction indicating the use of a complex glyph consisting of a combination of plural parts glyphs as a glyph of the character or other instruction and a rendering function of rendering each of the parts glyphs based on the information concerning the parts glyph acquired following the complex glyph instruction if the acquired instruction is determined as the complex glyph instruction.

2. The display program according to claim 1, wherein the information concerning the parts glyph contains a glyph index of the parts glyph, and the rendering function comprises a parts glyph acquisition function of acquiring the instruction indicated by the glyph index of the parts glyph and a first parts glyph rendering function of rendering the parts glyph based on the acquired instruction.

3. A data structure for use in a display program for displaying a character by acquiring an instruction for rendering each element composing the character and rendering the each element based on the instruction, wherein a complex glyph instruction indicating the use of a complex glyph consisting of a combination of plural parts glyphs as a glyph of the character is arranged before the information concerning the parts glyph.

4. A display device for displaying a character by acquiring an instruction for rendering each element composing the character and rendering the each element based on the instruction, comprising a determination section of determining whether the acquired instruction is a complex glyph instruction indicating the use of a complex glyph consisting of a combination of plural parts glyphs as a glyph of the character or other instruction and a rendering section of rendering each of the parts glyphs based on the information concerning the parts glyph acquired following the complex glyph instruction if the acquired instruction is determined as the complex glyph instruction.
